(19) United States
(12) Patent Application Publication
(10) Pub. No.: US 2007/0088234 A1
(43) Pub. Date: Apr. 19, 2007

(54) Inflatable massaging device for a human head

(76) Inventor: Jimmy Tseng, Fairfax, VA (US)

Correspondence Address: Jimmy Tseng, 12643 Buckleys Gate Drive, Fairfax, VA, 22030, US

(21) Appl. No.: 11/249,829

(22) Filed: Oct. 14, 2005

(51) Int. Cl. A61H 9/00

(52) U.S. Cl. 601/151; 601/148

(57) ABSTRACT

An inflatable massaging device for a human head having mainly an air bladder having a shape of a helmet and having end portions; a housing outside of the air bladder; a plurality of gussets and welding lines inside the air bladder for keeping the air bladder in a suitable shape and dividing the air bladder into several air cells; an air valve; hooks and loops for attaching end portions of the air bladder; a belt, a buckle and a chin guard for positioning the inflatable massaging device; a plurality of massage balls; and an air pump.

### FIELD OF THE INVENTION

This invention relates to an inflatable massaging device for human head, particularly to an inflatable massaging device for a human head that can be controlled by the user.

### BACKGROUND OF THE INVENTION

Massages or stimulation of pressure points can stimulate circulation and sooth the person. Conventionally, the massages or stimulation of pressure points on human heads are mostly done with fingers, some mechanical or electrical massaging devices. They are either time-consuming, expensive, not very accurate, not very convenient to carry, or require special technique or skills to carry out or use.

### SUMMARY OF THE INVENTION

A main objective of the present invention is to provide an inflatable massaging device for a human head, which is easy to use and does not require special technique or skills.

Another objective of the present invention is to provide an inflatable massaging device for a human head which is very convenient to carry and relatively inexpensive, and which can be used on cars, using the power source from the car.

Yet another objective of the present invention is to provide an inflatable massaging device for human head, which can do massage effectively and accurately.

A further objective of the present invention is to provide an inflatable massaging device for a human head which has a plurality of massage balls to enhance the effect of massaging or stimulation of pressure points.

### BRIEF DESCRIPTION OF THE DRAWINGS

FIG. 1 is a front perspective schematic view of the inflatable massaging device for human head;

FIG. 2 is a top view of FIG. 1 showing “A” portion and “B” portion in stretched position, with a central sectional line;

FIG. 3 is a side view of the “A” portion looking from the outside of the device;

FIG. 4 is a side view of the “A” portion looking from the inside of the device;

FIG. 5 is a side view of the “B” portion looking from the outside of the device;

FIG. 6 is a side view of the “B” portion looking from the inside of the device;

FIG. 7 is another perspective view of the device looking from an angle different from that of FIG. 1;

FIG. 8 and FIG. 9 show a rear view and a side view of a human head, with several pressure points specifically indicated;

FIG. 10 shows the position of the device on a human head;

FIG. 11 shows yet another perspective view of the device looking from the rear side;

FIGS. 12 to 14 are similar to FIG. 11, showing the different positions of adjustable portions;

FIG. 15 is a further perspective view of the device looking from an angle different from that of FIG. 1;

FIGS. 17 and 18 show the adjustment of the belt;

FIGS. 19 and 20 illustrate the effect of the magnets employed in the device;

FIG. 21 shows an example of inflating means air pump employed with the device;

FIG. 22 shows a perspective view of air pump used in the present invention;

FIG. 23 shows a perspective view of a portion of the air pump shown in FIG. 22;

FIG. 24 is a perspective view similar to FIG. 23, looking from a difference angle;

FIG. 25 is a top view of the parts shown in FIG. 23;

FIG. 26 is an exploded view of the parts shown in FIG. 23;

FIG. 27 is a longitudinal sectional view of the parts shown in FIG. 23;

FIG. 28 is a top view of the air pump, with a cover installed;

FIG. 29 is a bottom view of the air pump;

FIG. 30 is a schematic view depicting the hand and the air pump; and

FIG. 31 is a similar to FIG. 30, showing different angle.

### DETAILED DESCRIPTION OF A PREFERRED EMBODIMENT

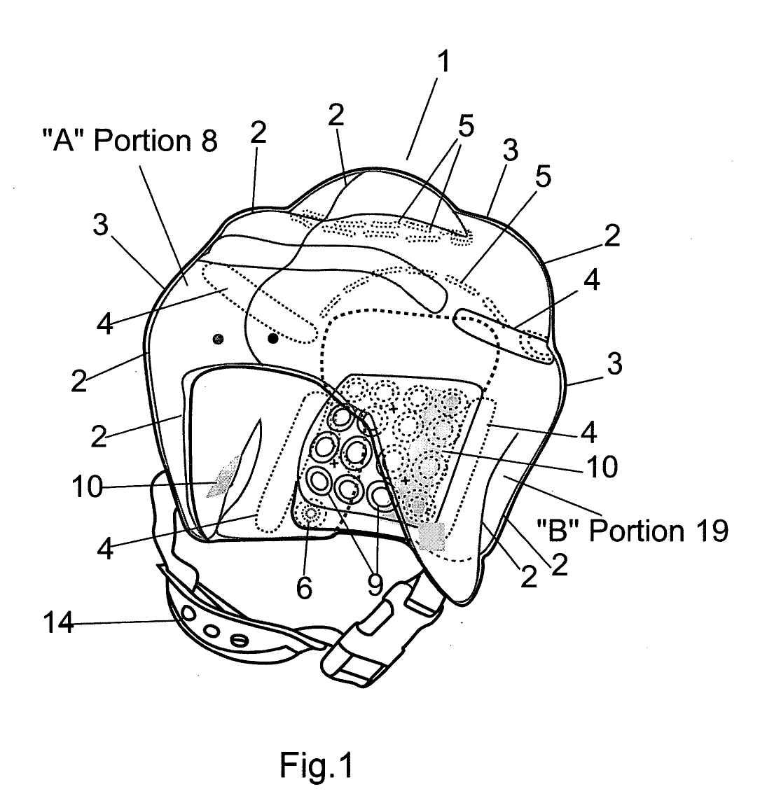

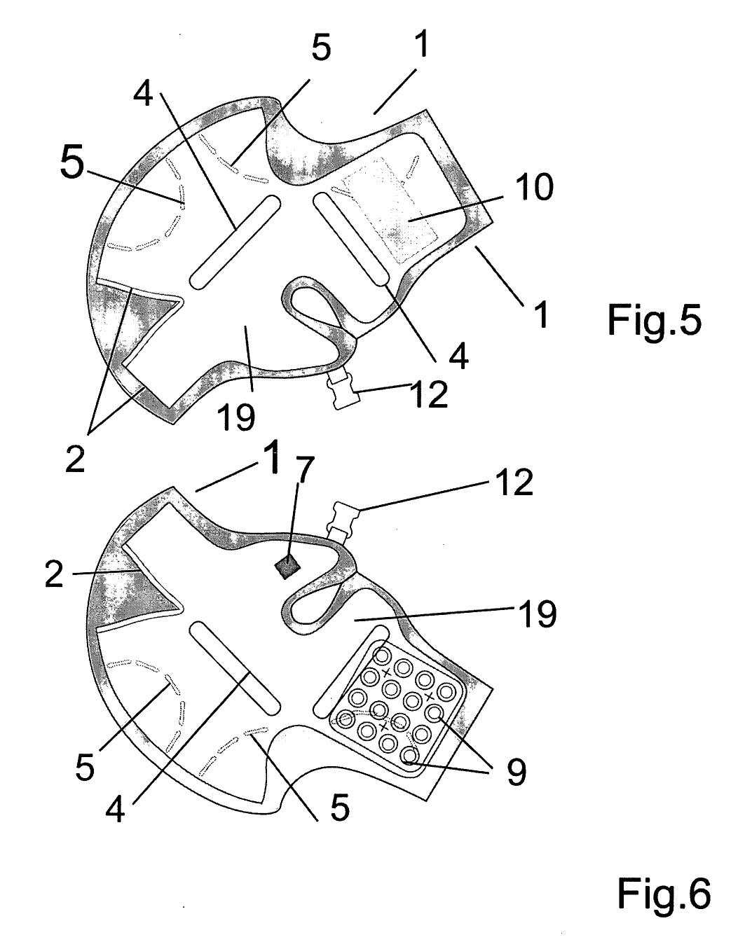

Please see FIGS. 1-6 for the description of a preferred embodiment.

Designating numeral 1 generally indicates an inflatable massaging device for human head. The overall shape of the device 1 looks similar to a helmet for motorcycle rider, comprises mainly an air bladder 2 covered with a housing (or shell) 3 which can be made of soft fabric or other suitable material. The air bladder 2 can be made of soft PVC (poly vinyl chloride), TPU (thermoplastic polyurethane), PU (polyurethane), or other suitable material. A plurality of gussets 4 are provided in the air bladder 2 for keeping two adjacent surfaces of the wall of the air bladder at an appropriate distance to each other. A plurality of welding lines 5 are employed to divide the air bladder 2 of the device 1 into several air cells so as to keep the air bladder 2 in an appropriate shape when it's inflated. The welding lines 5 is preferably in the form of broken lines, i.e. a section of line welded and a section of line un-welded can be arranged alternatively, on the welding lines 5. An air valve 6 can be provided on the air bladder 2 and the housing 3 so that the air can enter into or exit from the air bladder 2. A belt 13, a thin guard 14 and a pair of buckles 12 can be provided on the lower front portion of the device 1. The length of the belt 13 can be adjusted so as to adapt to different size of heads.

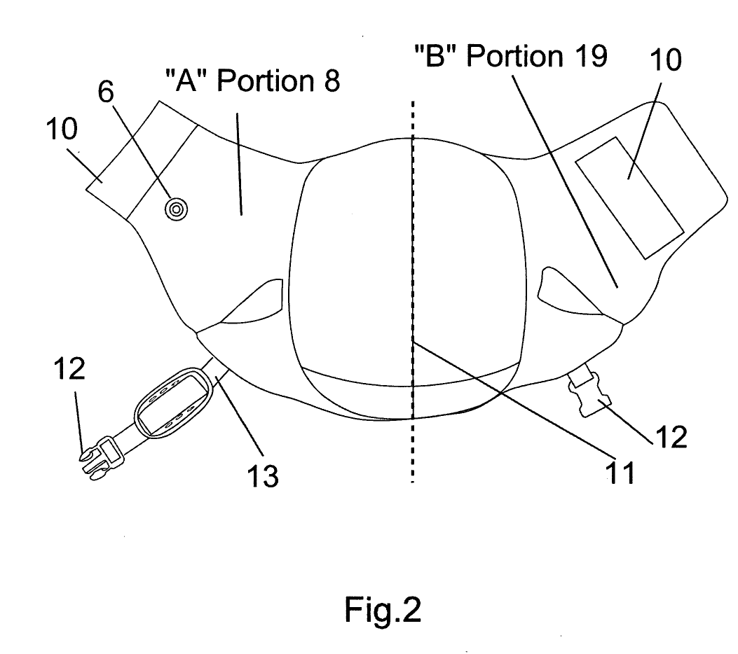

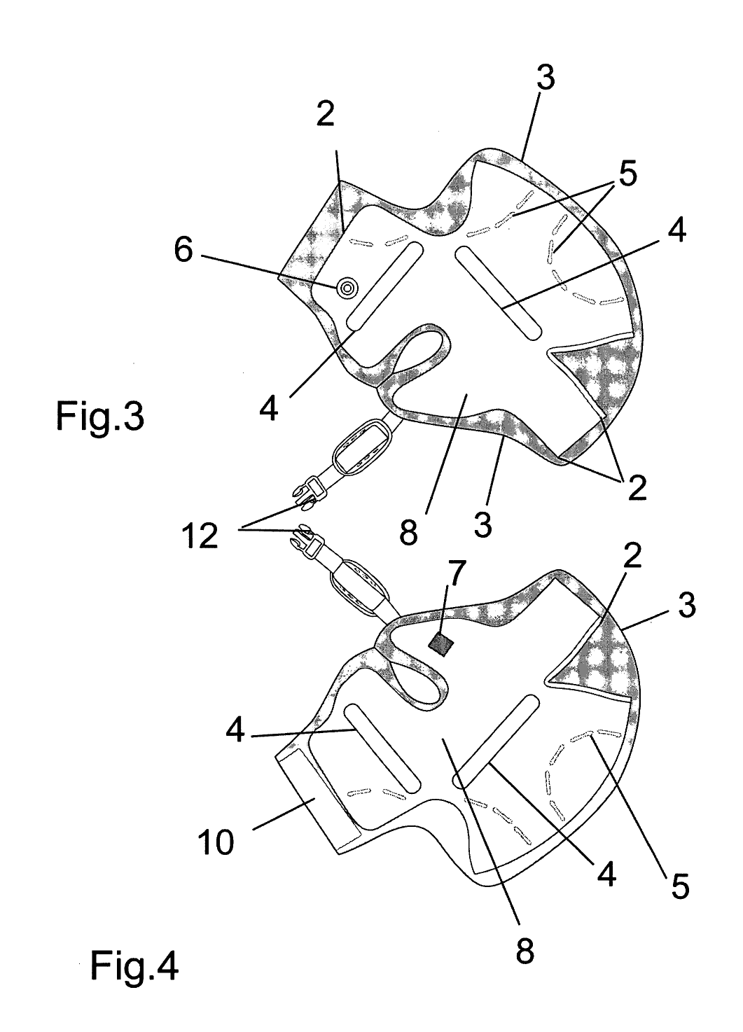

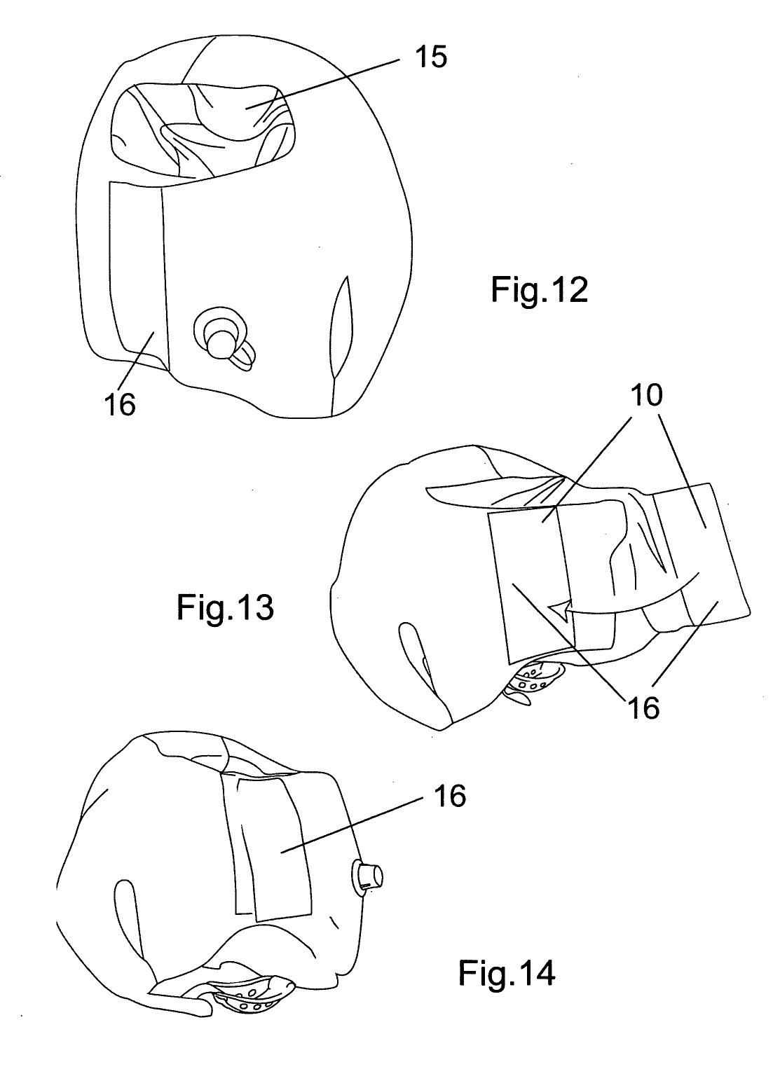

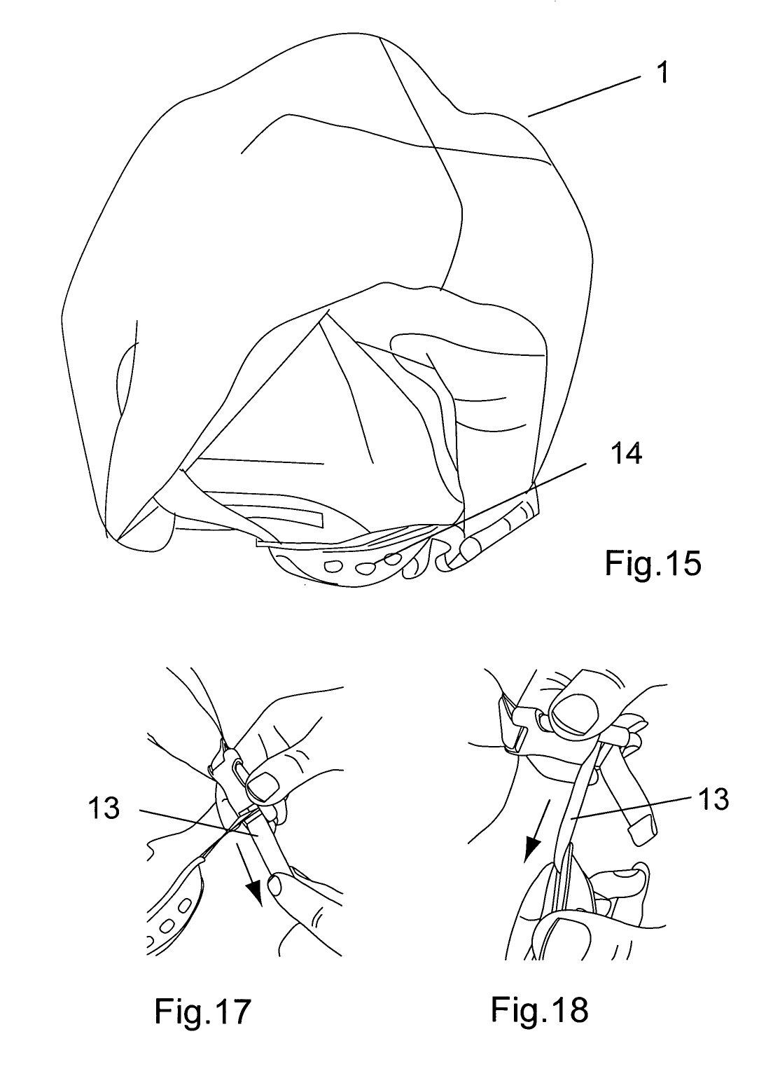

As show in FIG. 2, the device 1 is provided with an “A” portion 8, and a “B” portion 19 which are divided with a sectional line 11. The two portions 8 and 19 can be stretched so that the device 1 can be put on a head. The details of the two portions 8 and 19 are show in FIGS. 3-6. The “A” portion 8 and the “B” portion 19 are provided with hooks and loops (Velcro) 10, so that the two portions 8 and 19 can be attached together (please see FIGS. 13 and 14) before the inflatable massaging device 1 is inflated, there is no space between the chin guard 14 and the chin of the user. This can be achieved by adjusting the belt 13 as show in FIGS. 17 and 18. A plurality of massage balls 9 can be provided on the inside of the “B” portion 19 for stimulating some pressure points of the user. The massage balls 9 preferably are of semi-spherical shape.

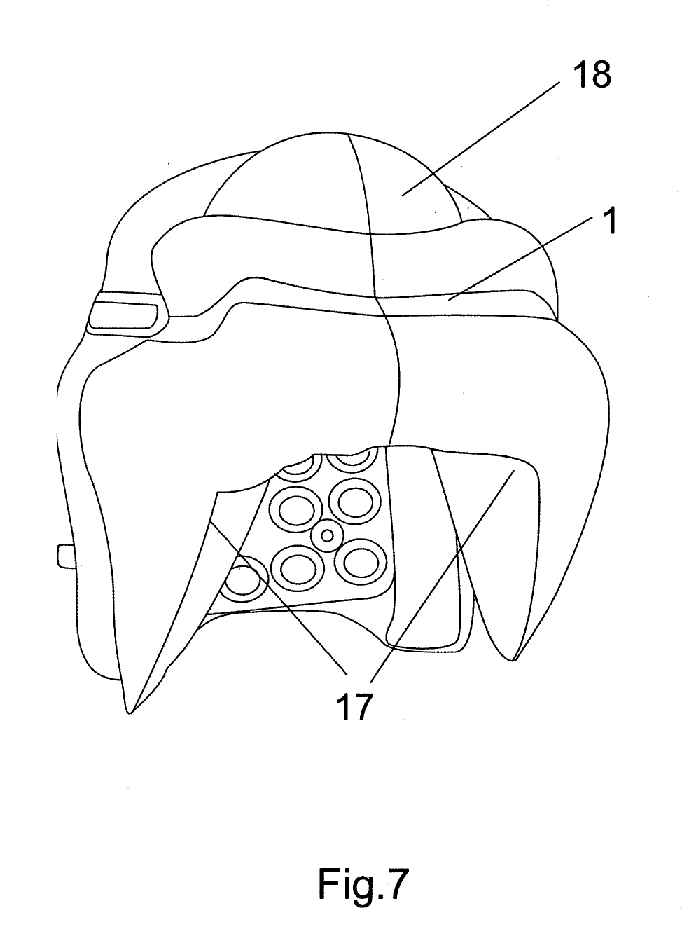

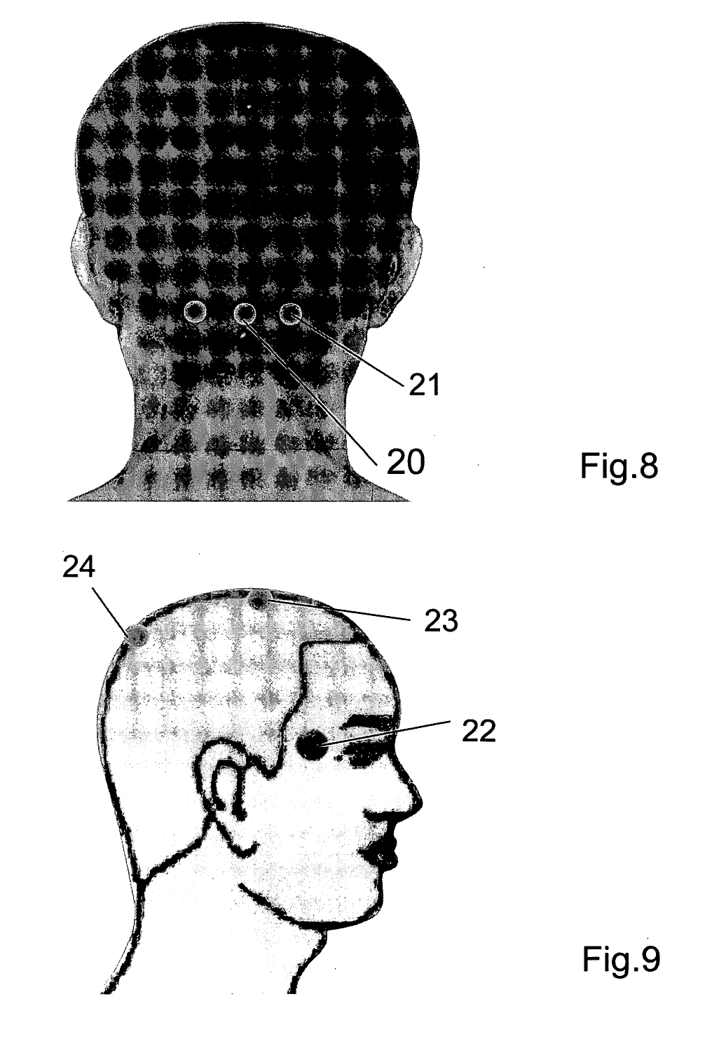

FIGS. 8-9 show a rear view and a side view of a human head, with several pressure points that this invention intends to stimulate specifically indicated, e.g. Tien Chu pressure point 20, Feng Chi pressure point 21, Superficial Temporal pressure point 22, Bai Hwei pressure point 23, and rear neck pressure point 24. From FIG. 7, we can see a portion 17 for pressing (stimulating) the Superficial Temporal pressure point 22, and a portion 18 for pressing the Bai Hwei pressure point 18.

In FIGS. 13 and 14, two portions 16 are each provided on the “A” portion 8 and “B” portion 19. The relative position of the two portions 16 can be adjustable to adapt to different size of the head of the user. It's preferable that a space of two fingers can be left between the inside of portion 16 and the head before the inflatable massaging device 1 is inflated.

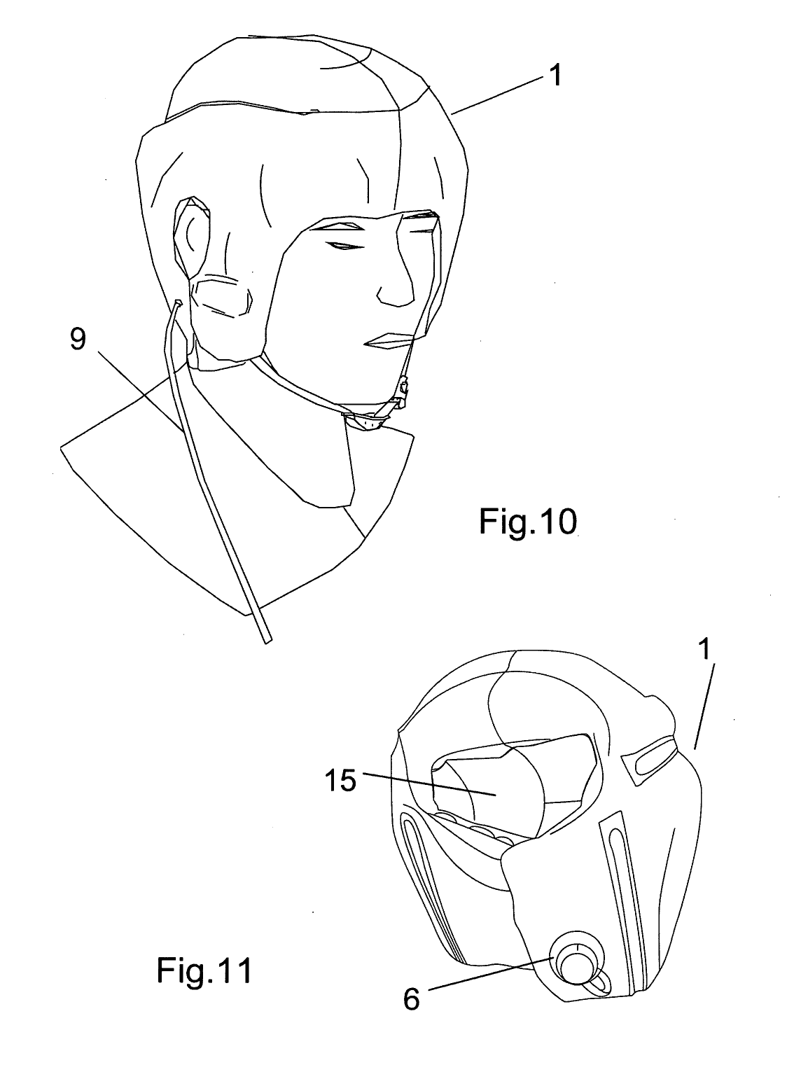

From FIG. 11, we can see an opening 15 formed on the upper rear side of the inflatable massaging device 1. The purpose of the opening 15 is to let the user “move” the hair inside the inflatable massaging device 1 outside, so that the massaging effect can be enhanced.

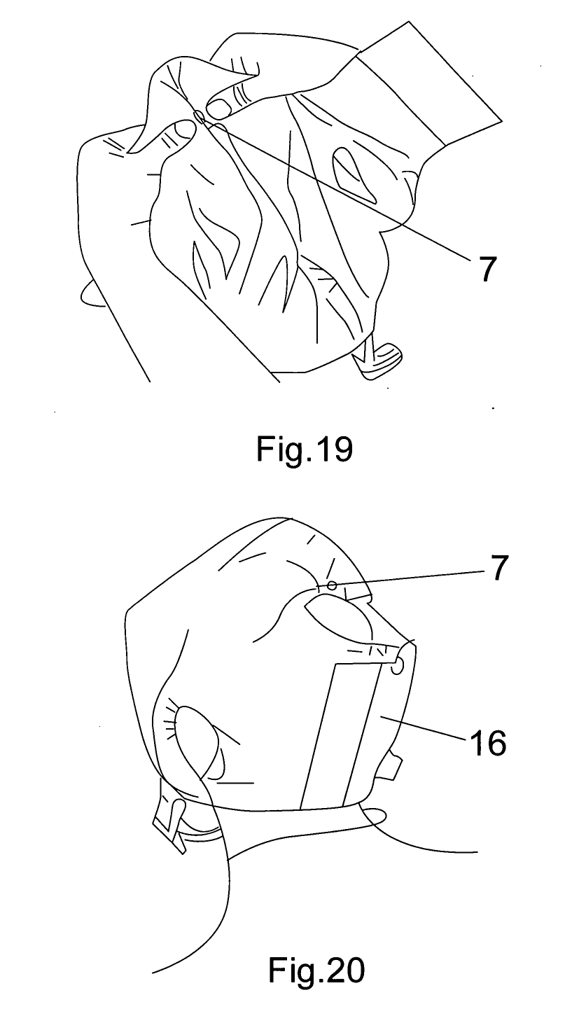

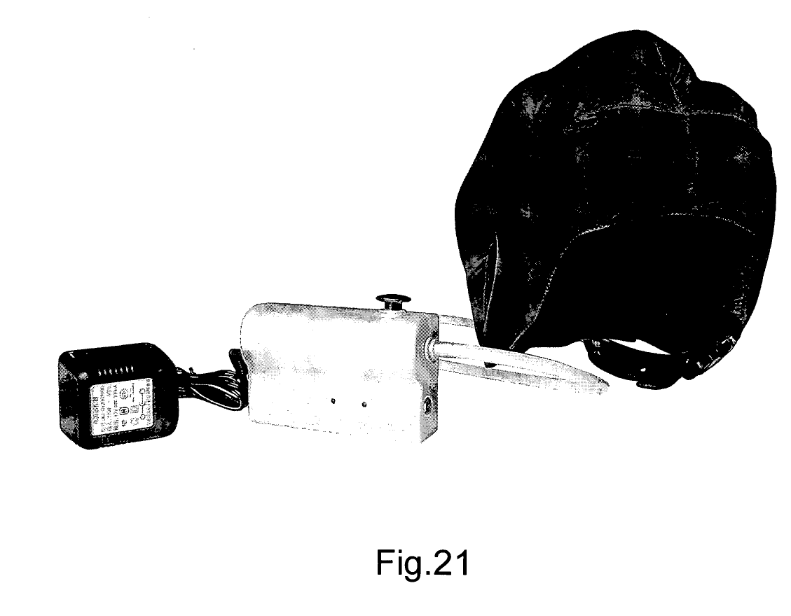

As seen from FIGS. 4, 6, 19 and 20, two magnets 7 is provided on the inside of the “A” portion 8 and “B” portion 19 respectively.

The purpose of the magnets is that if the user pushes slightly the top rear portion of the inflatable massaging device 1 when it is put onto the head, the two magnets 7 will attach to each other to prevent the eyes of the user from being covered by the inflatable massaging device 1.

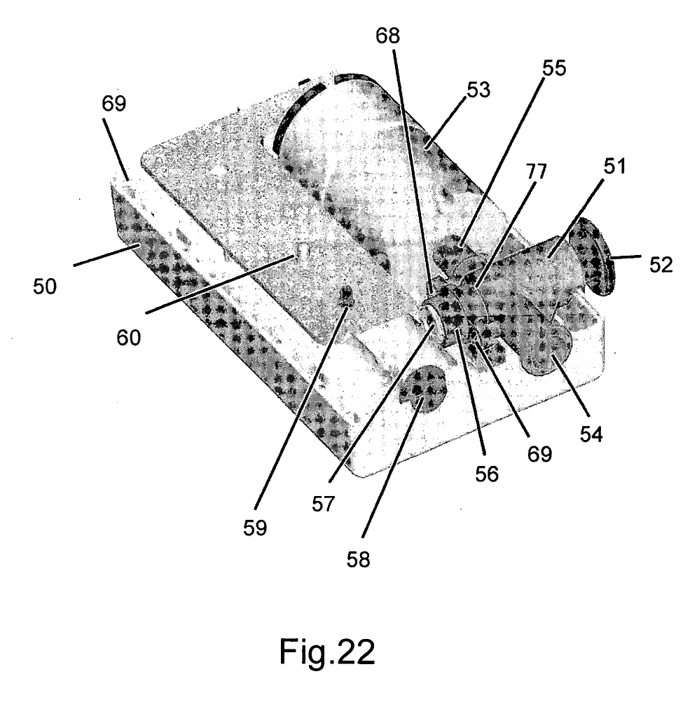

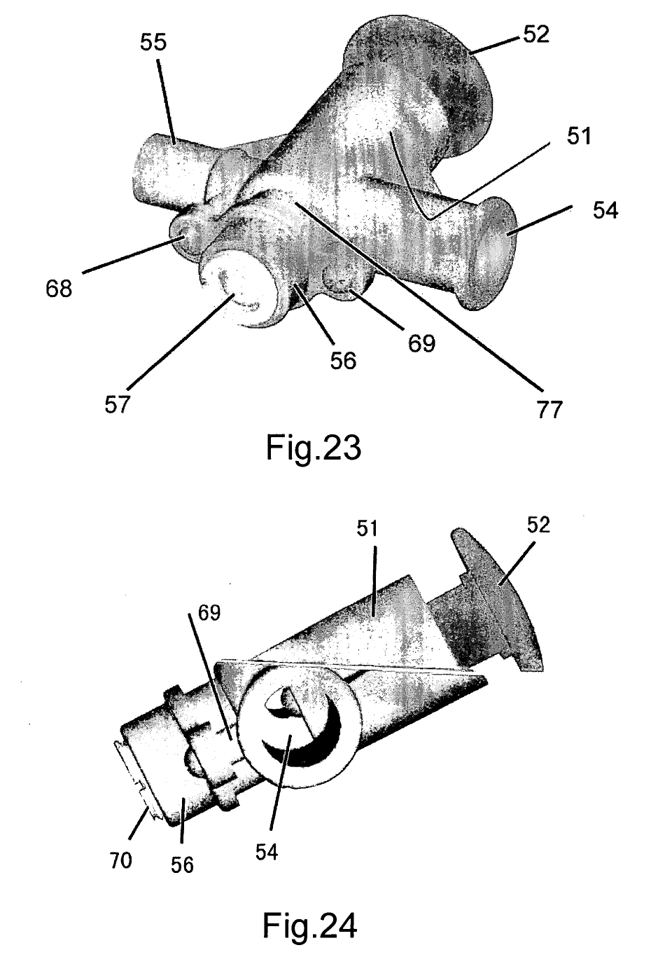

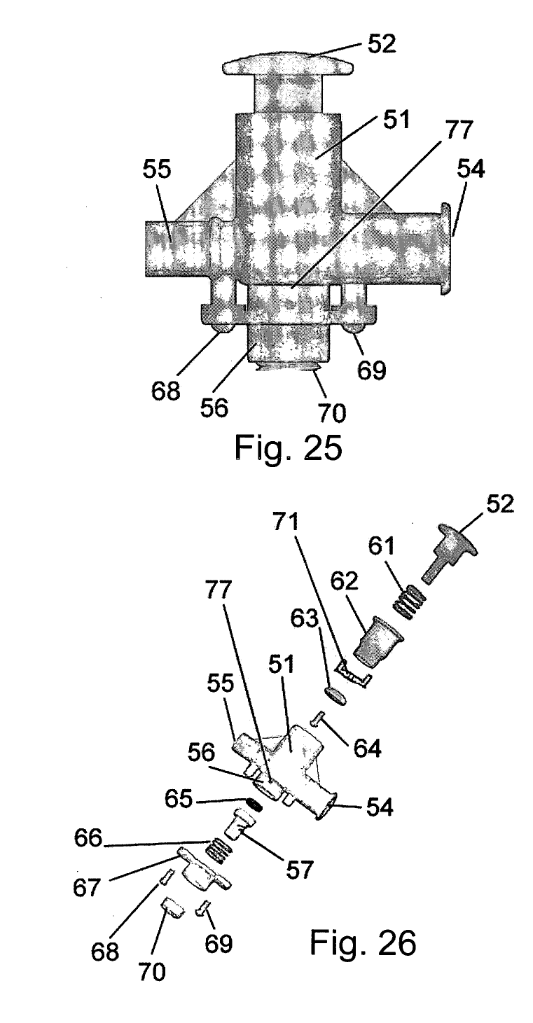

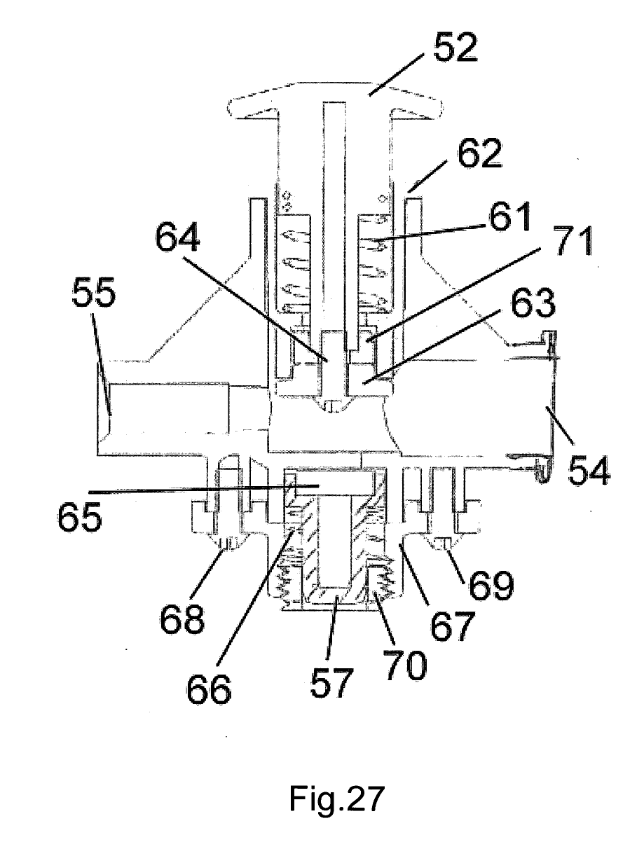

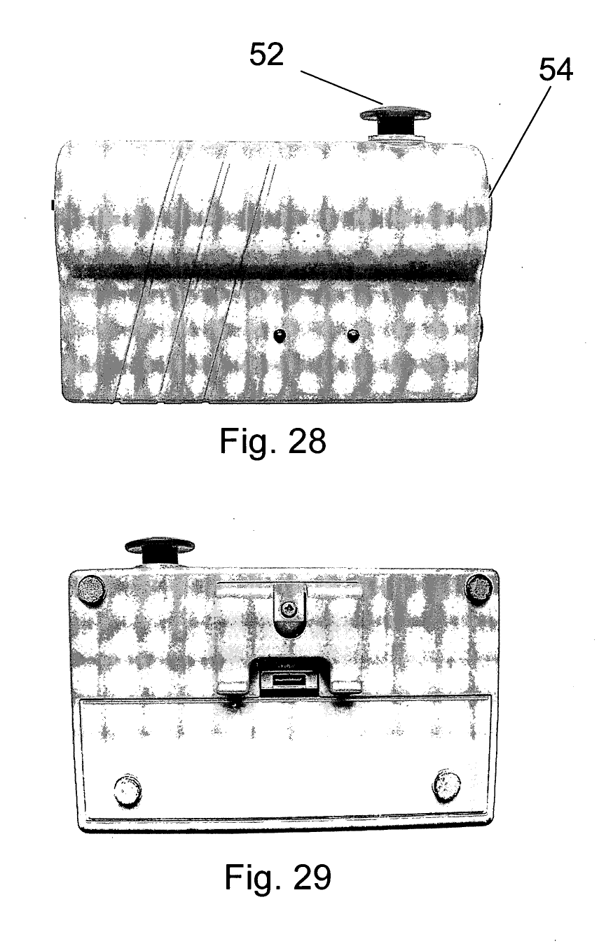

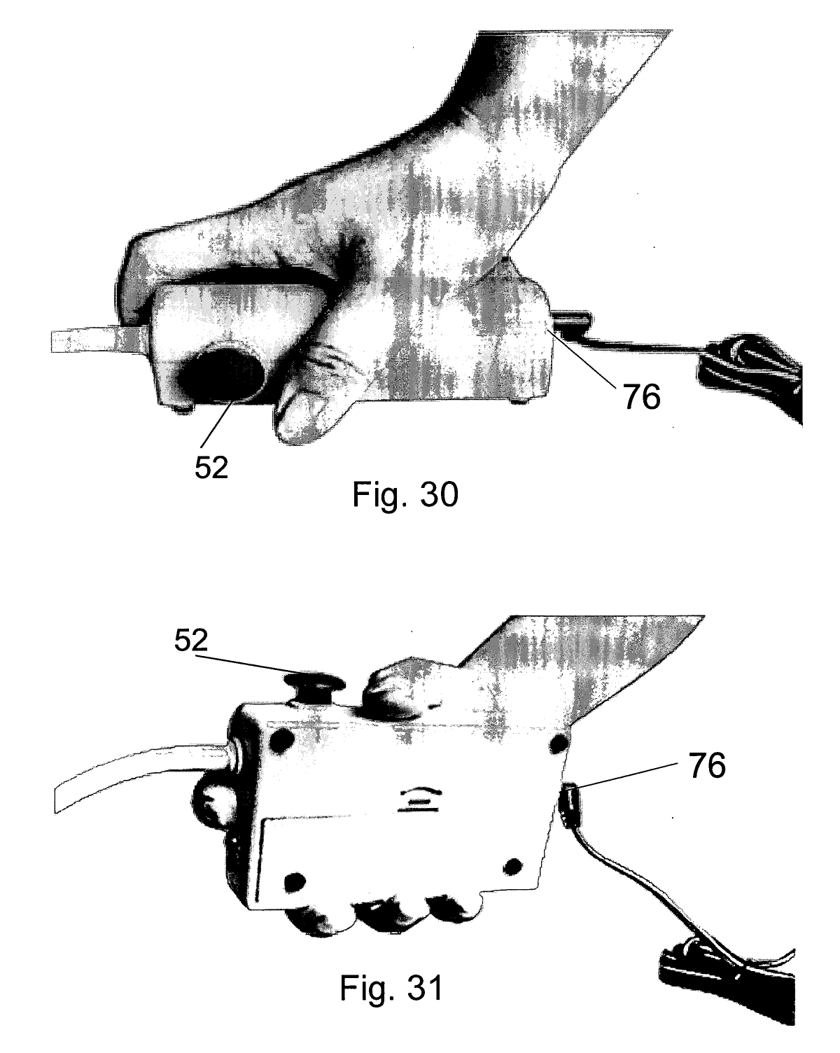

Please see FIGS. 22-27 for the detailed structure of the air pump 50. The air pump 50 comprises mainly a discharge valve button 52, a safety valve plunger 57, a pipe 51 for accommodating the discharge valve button 52 and relevant parts, a second pipe 56 for accommodating the safety valve plunger 57 and relevant parts, a pumping device 53, a pipe 55 in communicating with the pumping device 53, a pipe 54 for accommodating an end of an air tube having another end connected to the air valve of the inflatable massaging device of the present invention, and a starting button 58.

The discharge valve has the button 52, a spring 61, a socket 62, a fixation element 71, a piston 63, and a bolt 64 for fastening the button 52, the fixation element 71, and the piston 63 together. When the button 52 is pushed down, the piston 63, the fixation member 71 and the bolt 64 are pushed down simultaneously, and air can be discharged from an air release hole 77.

The safety valve has the plunger 57, a piston 65, a spring 66, a stopper 67, a micro-adjustment member 70, and two bolts 68 and 69 for fastening the stopper 67 to the pipes 54 and 55. The micro-adjustment member 70 and the stopper 67 have corresponding threads so that the member 70 can be rotated to adjust and set safety pressure which is preferably 0.015 MPA (mega Pascal). When the air pressure in the air tube or pipe 54 is more than the set value, the plunger 57 and the piston 65 is pushed downward by the air pressure and excessive air can be discharged from the air release hole 77.

Indicating light 59 indicates the inflation of the air pump 50, indicating light 60 indicates that the power is “on”, A switch 72 is provided on the housing of the air pump 50, A socket 73 is also provided on the housing of the air pump 50 for the insertion of a plug (line) 76 of an adapter (ac/dc converter), A clip (or hook) 74 is provided on the housing of the air pump 50 for attaching the air pump 50 on a belt or pocket of the user. A battery compartment 75 is also provided on the housing for accommodating batteries.

When the user's hand (finger, preferably forefinger) pushes down the starting button 58, the pumping device 53 is energized to provide air to the air valve on the inflatable massaging device of the present invention through the pipes 53 and 54, and an air tube (not shown in the drawings), and thus the inflatable massaging device is inflated when the user's hand (finger, preferably thumb) pushes down the safety valve plunger 57, air from the inflatable massaging device is discharged at air release hole 77 through the air valve, air tube, and the pipe 54, and thus the inflatable massaging device can be deflated.

In actual use, the user can choose one of the following three ways, or other suitable ways;
1. Push and release: the user continuously inflate the inflatable massaging device until the user can not tolerate, then deflate the same, then inflate and deflate it alternatively;
2. Continuous inflation: the user inflate the inflatable massaging device fully, then discharge about half of the air in that device, and then inflate it fully again. These steps can be repeatedly done.
3. Full inflation and full release: the user inflate the inflatable massaging device fully, then turn off the air pump 50, let the air stay in the inflatable massaging device for a while (eg. 3-5 minutes), then deflate the inflatable massage device. These steps can be repeatedly done.

The purpose of alternatively inflating and deflating the inflatable massaging device is to exert pressure to the user's body part so as to massage it and stimulate pressure points; then let the body part relaxed when it is deflated.

1. An inflatable massaging device for a human head comprising mainly an air bladder having a shape of a helmet and having end portions; a housing outside of the air bladder; a plurality of gussets and welding lines inside the air bladder for keeping the air bladder in a suitable shape and dividing the air bladder into several air cells; an air valve provided on the air bladder and the housing; hook and loops for attaching end portions of the air bladder and the housing; a belt, a buckle and a chin guard for positioning the air bladder and the housing on a user's head; a plurality of massage balls provided inside of the inflatable massaging device at positions corresponding to some pressure points of the user to be stimulated; and an air pump.

2. The inflatable massaging device as in claim 1, wherein an opening is formed on the rear upper side of the inflatable massaging device so that the user can move some hair from inside of the device to outside.

3. The inflatable massaging device as in claim 1, wherein two magnets are provided inside of the inflatable massaging device so that the two magnets can attach to each other when the user is putting the inflatable massaging device and thus the eyes of the user can be prevented from being covered by the inflatable massaging device.

4. The inflatable massaging device as in claim 1, wherein the air pump comprises mainly a housing, a safety valve, a discharge valve, a pumping device, a starting button, and indicating lights.

5. The inflatable massaging device as in claim 4, wherein the safety valve includes a plunger, a piston, a spring, a stopper, a micro-adjustment member, and two bolts.

6. The inflatable massaging device as in claim 4, wherein the discharge valve includes a button, a spring, a socket, a fixation element, a piston, and a bolt.
